(19) United States
(12) Patent Application Publication
(10) Pub. No.: US 2003/0231321 A1
(43) Pub. Date: Dec. 18, 2003

(54) Method of and system for image processing, method of and apparatus for image generation, and computer program

(76) Inventor: Tatsuya Aoyama, Kanagawa-ken (JP)

Correspondence Address: BIRCH STEWART KOLASCH & BIRCH, PO BOX 747, FALLS CHURCH, VA, 22040-0747, US

(21) Appl. No.: 10/395,201

(22) Filed: Mar. 25, 2003

(30) Foreign Application Priority Data
Mar. 25, 2002 (JP) 083510/2002
Mar. 25, 2002 (JP) 083511/2002
Mar. 25, 2002 (JP) 083512/2002
Mar. 27, 2002 (JP) 089053/2002

(51) Int. Cl. H04N 1/407; H04N 1/409; G06T 5/00; G06K 15/02

(52) U.S. Cl. 358/1.2; 358/3.27; 382/260

(57) ABSTRACT

A predetermined image processing is carried out on image data taken in through one of a plurality of kinds of input devices and the processed image data is output through one of a plurality of kinds of output devices. First image processing is carried out on the image data to transform structure of image on the assumption that the image data is output through a supposed output device, and first processed image data is obtained on the basis of which an image having structure conforming to the supposed output device can be reproduced. Second image processing is carried out on the first processed image data to compensate for difference in output properties between the supposed output device and the output device which actually outputs the image data and second processed image data is obtained as a final image data to be output.

### BACKGROUND OF THE INVENTION

1. Field of the Invention

This invention relates to a method of and system for image processing and a method of and apparatus for image generation. This invention also relates to a computer program for causing a computer to execute the methods.

2. Description of the Related Art

There has been used in various fields an image reproduction system for obtaining a reproduced image by carrying out predetermined image processing such as gradation adjustment and/or sharpness correction on image data taken in by an input device such as an image scanner or an image read-out apparatus and outputting processed image data to an output device such as a monitor or a printer. Generally, in such an image reproduction system, the input device, the image processing apparatus and the output device have been in one-to-one correspondence with each other. However recent development of computers, workstations, and the like increases open systems which conform to a plurality of kinds of input devices and/or output devices. Such open systems include, for instance, those which carries out image processing by an workstation on image data read out by an image read-out apparatus and reproduces an image on the basis of the processed image data by a printer and a CRT, and those which takes in an original image through an image read-out apparatus and a digital camera, carries out image processing by an workstation on the respective pieces of image data, and reproduces images respectively on the basis of the two pieces of processed image data.

In the open system, it is required that the same reproduction images can be stably obtained irrespective of the kind of the input device or the output device so long as the same original image is processed. However the properties of the input devices and the output devices generally differ by the devices and in the open system comprising a plurality of kinds of input devices and output devices, the structure of the reproduced image varies depending on the input device or the output device used even if the image is reproduced by the use of the same original image.

There has been proposed a method of image processing where sharpness processing is carried out on input image data taking into account the spatial frequency properties of the input device and the output device used. See, for instance, Japanese Patent No. 3143458. However, this method is based on the assumption that the kinds of the input device and the output device used are known, and when the kinds of the input device and the output device used are unknown, proper sharpness processing cannot be carried out on the image data.

In order to overcome this problem, we, this applicant, has proposed, in U.S. Pat. No. 6,281,992, an image processing method in which first sharpness processing is carried out on image data on the basis of the MTF properties (spatial frequency properties) of the input device used, thereby obtaining first processed image data, and then second image processing is further carried out on the first processed image data on the basis of the MTF properties of the output device to be used, thereby obtaining final processed image data having sharpness conforming to the output device to be used.

However, the quality of the image output through the output device is affected by not only the sharpness but also noise. The method disclosed in the above identified U.S. patent publication is disadvantageous in that sharpness processing is carried out taking into account only the MTF properties of the input device and the output device without taking into account the noise properties of the image data input through the input device, and accordingly, the final processed image data obtained through the output device cannot be properly corrected with the noise, which fluctuates depending on the kind of input device used, though properly corrected with the sharpness. As a result, the reproduced image varies in structural quality depending on the input device used.

Further, recently, to store image data obtained by the input device in a portable image recording media such as CD-R, MO, or a memory card or in a hard disc of a personal computer and to reproduce an image on the basis of the image data by a monitor or a printer is done. When image data is once stored as in this case, the output device through which the image data is output is not known and accordingly, how to adjust the image quality when storing the image data cannot be determined.

This problem may be overcome by carrying out image processing such as sharpness processing or noise removal processing on image data on the basis of the output size and resolution of a supposed general purpose output device and storing the processed image data. However, image data obtained by a digital camera for professional use or a high-quality scanner has numerous pixels and is rich in image information, and accordingly when the supposed output device is small in output size or low in resolution, the rich image information of such image data is thinned.

We, this applicant, has proposed various sharpness processing methods for improving the sharpness of an image by the use of unsharp mask image data (will be referred to as “blurred image data”, hereinbelow.) as disclosed, for instance, in Japanese Unexamined Patent Publication No. 3(1991)-222577 and U.S. Pat. Nos. 4,315,318, 4,317,179, 5,991,457, and 6,072,913. In an example of the sharpness processing methods, a predetermined spatial frequency component is enhanced by adding to original image data Sorg the product of an enhancement coefficient β and the remainder left by subtracting blurred image data Sus from the original image data Sorg. This is represented by the following formula (1).

Sproc=Sorg+β×(Sorg−Sus) (1)

wherein Sproc represents the processed image data, Sorg represents the original image data, Sus represents the blurred image data and β represents the enhancement coefficient.

The blurred image data Sus is obtained by carrying out filtering processing using an unsharp mask on original image data Sorg. As the unsharp mask, a filter for two-dimensionally carrying out filtering processing on the original image data Sorg (e.g., 3×3 or 5×5) is used.

When matching images output through different output media (which are different in print size, e.g., L-size or A4-size or in output device, e.g., a monitor or a printer) with each other in structural look so that images can be matched in structural look irrespective of the kinds of output medium, generally a certain viewing distance is supposed and the sharpness in a frequency band where the human eye is higher in sensitivity at the supposed viewing distance is improved.

However, actually, the viewing distance differs depending especially on the size of the output medium. For example, the viewing distance is slightly larger in an A4-size print than in an L-size print.

Accordingly, when sharpness processing is carried out on the basis of a constant viewing distance, the sharpness in a frequency band not conforming to the actual viewing distance and the structural look of images varies depending on the size of the output medium.

Generally an image recorded on a photographic film is directly printed on a photosensitive material. Whereas recently, to store image data, obtained by reading an image recorded on a negative film by an image scanner or an image read-out apparatus, or image data, obtained by a digital camera, in an image recording media such as CD-R, MO, or a hard disc and to reproduce an image on the basis of the image data stored in the media is often done. The former will be referred to as “simultaneous print system” and the latter will be referred to as “subsequent print system” in this specification.

It is important that equivalent images can be obtained whichever print system is employed. In the simultaneous print system, the image is often printed in L-size. Conventionally supposing that the image is printed in L-size also in the subsequent print system, image data of a size (number of dots) suitable for L-size print is stored in the media after subjected to “image structure transformation processing” which transforms the image data so that the print obtained therefrom is matched in structural look with that obtained by the simultaneous print system (the prints are the same in sharpness and/or granularity).

However, in the subsequent print system, the image can be printed in not only L-size but also in various size such as 2L-size, postcard-size and A4-size. When the image is printed in a size different from L-size, the image is enlarged or reduced. It is important from the viewpoint of image quality management that the prints obtained by the simultaneous print system and the subsequent print system are matched with each other in structural look.

### SUMMARY OF THE INVENTION

In view of the foregoing observations and description, a first object of the present invention is to obtain images which are of the same structural quality irrespective of the kind of input device or output device used when image data is output through a system comprising a plurality of input devices and a plurality of output devices.

A second object of the present invention is to prevent image information from being thinned when image processing is carried out on image data on the assumption that the processed image data is to be output through a supposed output device.

A third object of the present invention is carrying out sharpness processing on image data on the basis of a real viewing distance from which an image reproduced on the basis of the processed image data.

A fourth object of the present invention is to obtain images which are the same in structural look irrespective of the print sizes in the subsequent print system.

The first object of the present invention can be accomplished by an image processing method of carrying out predetermined image processing on image data taken in through one of a plurality of kinds of input devices and outputs the processed image data through one of a plurality of kinds of output devices, wherein the improvement comprises the steps of

carrying out first image processing on the image data to transform structure of image on the assumption that the image data is output through a predetermined supposed output device, thereby obtaining first processed image data on the basis of which an image having structure conforming to the supposed output device can be reproduced,

carrying out second image processing on the first processed image data to compensate for difference in output properties related to structure of image between the supposed output device and said one of a plurality of kinds of output devices, thereby obtaining second processed image data, and

outputting the second processed image data through said one of a plurality of kinds of output devices.

When the supposed output device is too low in resolution and/or too small in output size, the amount of data in the first processed image data is reduced as compared with the original image data, which results in loss of information. Whereas, when the supposed output device is too high in resolution and/or too large in output size, the amount of data in the first processed image data becomes too large in spite that the resolution of the reproduced image is not sometimes greatly visually improved. Accordingly, it is preferred that the supposed output device be an output device which outputs image data at resolution and size which are frequently used. For example, a supposed output device which prints out image in a post-card size at a resolution of 300 to 400 dpi will be sufficient for the general purpose.

“To transform structure of image” means to change sharpness and/or granularity of the image, and the “first image processing” may comprise sharpness processing and/or noise removal processing depending upon properties of the image, such as edges and contrast.

Since the first processed image data is capable of reproducing an image having structure conforming to the supposed output device but is incapable of reproducing an image having structure conforming to said one of a plurality of kinds of output devices, which actually outputs the image, “carrying out second image processing on the first processed image data to compensate for difference in output properties related to structure of image between the supposed output device and said one of a plurality of kinds of output devices” means carrying out image processing on the first processed image data so that difference in structure between an image reproduced through the supposed output device on the basis of the first processed image data and an image reproduced through said one of a plurality of kinds of output devices on the basis of the second processed image data is nullified.

For example, there sometimes exists difference in image sharpness between the supposed output device and the output device which actually outputs the image. Further when the supposed output device differs in resolution from the output device which actually outputs the image, enlargement/reduction processing must be carried out on the first processed image data. However enlargement/reduction processing deteriorates the sharpness of the image. Accordingly, the second image processing is, for instance, image-property-independent processing for compensating for sharpness difference and change of visual properties with such deterioration in sharpness and/or change of resolution.

A computer program for causing a computer to perform the image processing method of the present invention may be recorded in a computer readable medium so that the computer can perform the method when loaded with the recording medium. A skilled artisan would know that the computer readable medium is not limited to any specific type of storage devices and includes any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of this invention. Additionally, computer code/instructions include, but are not limited to, source, object and executable code and can be in any language including higher level languages, assembly language and machine language.

The first object of the present invention can be accomplished by an image processing system for carrying out predetermined image processing on image data taken in through one of a plurality of kinds of input devices and outputs the processed image data through one of a plurality of kinds of output devices, wherein the improvement comprises

a first image processing means which carries out first image processing on the image data to transform structure of image on the assumption that the image data is output through a predetermined supposed output device, thereby obtaining first processed image data on the basis of which an image having structure conforming to the supposed output device can be reproduced, and

a second image processing means which carries out second image processing on the first processed image data to compensate for difference in output properties related to structure of image between the supposed output device and said one of a plurality of kinds of output devices, thereby obtaining second processed image data,

the second processed image data being output through said one of a plurality of kinds of output devices.

In accordance with the image processing method and system for accomplishing the first object, since first image processing is carried out on the image data to transform structure of image on the assumption that the image data is output through a predetermined supposed output device and first processed image data on the basis of which an image having structure conforming to the supposed output device can be reproduced is obtained, the first processed image data is capable of reproducing an image of the same quality in structure irrespective of the kind of input device used.

Further, since second image processing is carried out on the first processed image data to compensate for difference in output properties related to structure of image between the supposed output device and said one of a plurality of kinds of output devices when outputting an image through said one of a plurality of kinds of output devices, processed image data capable of reproducing an image of the same quality in structure irrespective of the kind of input device used can be obtained. Further, since when outputting an image through said one of a plurality of kinds of output devices, only image processing to compensate for difference in output properties related to structure of image between the supposed output device and said one of a plurality of kinds of output devices is carried out, processed image data can be easily obtained.

The second object of the present invention can be accomplished by an image processing method of carrying out predetermined image processing on image data taken in through an input device comprising the steps of

obtaining resolution information on the resolution of the image data,

setting output resolution on the basis of the resolution information on the assumption that the image data is output through a predetermined supposed output device having a predetermined output resolution, and

carrying out image processing on the image data to transform structure of image according to the set output resolution, thereby obtaining processed image data on the basis of which an image having structure conforming to the supposed output device can be reproduced.

Though, the “resolution information” may represent simply the number of pixels in the image represented by the image data, resolution can differ according to the kind of the input device even if the number of pixels is the same. For example, in the case of image data comprising three color data components of RGB, image data obtained by reading an original by an image scanner has originally three pieces of image information (of three colors) for each pixel. Whereas, image data obtained through a digital camera has originally only one piece of image information (of one of the three colors) for each pixel since a monolayer CCD for obtaining three color data components on each pixel is generally employed and pieces of image information of the other two colors are obtained by interpolation. Accordingly, even if the same in the number of pixels, image data obtained through an image scanner is higher in resolution than image data obtained through a digital camera. Further even for image data obtained through an image scanner, resolution varies according to the original scan mode, high image quality mode or high speed mode. Further even for image data obtained through an image scanner and in the same mode, resolution varies according to the size of the original, 135 film, APS film or Brownie film.

Accordingly, it is preferred that the resolution information includes, as well as the number of pixels, various types of information affecting the resolution of image data such as on the kind of the input device, the scan mode, the original size and the like. These pieces of information may be directly obtained from the input device. However if these pieces of information are recorded on a tag or a header, these information can be obtained by referring to the tag or the header.

The “output resolution” means a physical output size or a physical resolution such as print size in which an image is output. For example, when the supposed output device output a print in L-size at a resolution of 300 dpi, the output resolution is 300 dpi, L-size. “To transform structure of image” means to change sharpness and/or granularity of the image, and the “image processing” may comprise sharpness processing and/or noise removal processing.

The output resolution may be set by selecting an output resolution corresponding to the resolution information from a plurality of values of output resolution.

The output resolution may be set by receipt of input of the output resolution.

A computer-program for causing a computer to perform the image processing method of the present invention may be recorded in a computer readable medium so that the computer can perform the method when loaded with the recording medium. A skilled artisan would know that the computer readable medium is not limited to any specific type of storage devices and includes any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of this invention. Additionally, computer code/instructions include, but are not limited to, source, object and executable code and can be in any language including higher level languages, assembly language and machine language.

The second object of the present invention can be accomplished by an image processing apparatus for carrying out predetermined image processing on image data taken in through an input device comprising

a resolution information obtaining means which obtains resolution information on the resolution of the image data,

an output resolution setting means which sets output resolution on the basis of the resolution information on the assumption that the image data is output through a predetermined supposed output device having a predetermined output resolution, and

an image processing means which carries out image processing on the image data to transform structure of image according to the set output resolution, thereby obtaining processed image data on the basis of which an image having structure conforming to the supposed output device can be reproduced.

The output resolution setting means may set the output resolution by selecting an output resolution corresponding to the resolution information from a plurality of values of output resolution.

The output resolution setting means may set the output resolution by receipt of input of the output resolution.

In accordance with the image processing method and apparatus for accomplishing the second object, since resolution information on the resolution of the image data is obtained, output resolution is set on the basis of the resolution information on the assumption that the image data is output through a predetermined supposed output device having a predetermined output resolution, and an image processing is carried out on the image data to transform structure of image according to the set output resolution, the output resolution of the supposed output device can be set high when the resolution of the image data is high, whereby image processing to transform structure of image can be carried out without loss of image information.

When the output resolution is set by selecting an output resolution corresponding to the resolution information from a plurality of values of output resolution, setting of the output resolution is facilitated.

When the output resolution is set by receipt of input of the output resolution, the output resolution of the supposed output device can be freely set. Accordingly, for instance, when it is not necessary to store high-resolution image data with the resolution kept high, the output resolution can be set to general-purpose output resolution, whereby processed image from which an image having structure conforming to the desired output resolution can be reproduced can be obtained.

The third object of the present invention can be accomplished by an image processing method for carrying out sharpness processing on image data to obtain processed image data wherein the improvement comprises the steps of

setting a parameter of the sharpness processing on the basis of output size and output resolution of the processed image data, and

carrying out the sharpness processing on the basis of the set parameter.

A computer program for causing a computer to perform the image processing method of the present invention may be recorded in a computer readable medium so that the computer can perform the method when loaded with the recording medium. A skilled artisan would know that the computer readable medium is not limited to any specific type of storage devices and includes any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of this invention. Additionally, computer code/instructions include, but are not limited to, source, object and executable code and can be in any language including higher level languages, assembly language and machine language.

The third object of the present invention can be accomplished by an image processing apparatus for carrying out sharpness processing on image data to obtain processed image data wherein the improvement comprises

a parameter setting means which sets a parameter of the sharpness processing on the basis of output size and output resolution of the processed image data, and

a sharpness processing means which carries out the sharpness processing on the basis of the set parameter.

In accordance with the image processing method and apparatus for accomplishing the third object, since a parameter of the sharpness processing is set on the basis of the output size and output resolution of the processed image data, sharpness processing which improves the sharpness in a frequency band where the human eye is higher in sensitivity at the viewing distance for the output size can be carried out on the image data. Further, sharpness processing which is suitable for the output resolution of the processed image data (which also can affect the parameter of sharpness processing) can be carried out on the image data since the parameter of sharpness processing is set on the basis of the output resolution. Accordingly, image data from which an image which is substantially constant in structural look irrespective of the viewing distance, which varies according to the output size, can be reproduced can be obtained.

The fourth object of the present invention can be accomplished by an image generation method of generating image data which is displayed on a display medium, wherein the improvement comprises the step of

attaching to the image data a processing parameter for carrying out image structure transformation processing on the image data so that an image reproduced from the image data is of structure conforming to the various sizes in which the image is displayed.

The “display medium” may be any so long as it can display an image on the basis of image data. For example, the display medium may be a print, a CRT monitor, a liquid crystal display, an electronic paper or a projector.

The “image structure transformation processing” may comprise, for instance, sharpness processing and/or noise removal processing.

The “processing parameter” means a parameter which governs the degree of sharpness processing and/or the noise removal.

In the case where the display medium is a print, the image data may be generated on the assumption that the image data is printed in a reference print size with the various sizes being print sizes different from the reference print size.

The image data attached with the processing parameter may be stored in a recording medium such as a hard disc, a CD-R, an MO, or a memory card.

A computer program for causing a computer to perform the image generation method of the present invention may be recorded in a computer readable medium so that the computer can perform the method when loaded with the recording medium. A skilled artisan would know that the computer readable medium is not limited to any specific type of storage devices and includes any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of this invention. Additionally, computer code/instructions include, but are not limited to, source, object and executable code and can be in any language including higher level languages, assembly language and machine language.

The fourth object of the present invention can be accomplished by an image generation apparatus for generating image data which is displayed on a display medium, wherein the improvement comprises

a processing parameter attaching means which attaches to the image data a processing parameter for carrying out image structure transformation processing on the image data so that an image reproduced from the image data is of structure conforming to the various sizes in which the image is displayed.

The “display medium” may be may be a print.

The image data may be generated on the assumption that the image data is printed in a reference print size with the various sizes being print sizes different from the reference print size.

The image generation apparatus may further comprises a storing means which stores image data attached with the processing parameter in a recording medium.

In accordance with the image generation method and apparatus for accomplishing the fourth object of the present invention, a processing parameter for carrying out image structure transformation processing on the image data so that an image reproduced from the image data is of structure conforming to the various sizes in which the image is displayed can be easily obtained, and when the image data is processed on the basis of the processing parameter, processed image data from which an image which is constant in structural look irrespective of the display size can be reproduced can be obtained.

### BRIEF DESCRIPTION OF THE DRAWINGS

FIG. 1 is a block diagram showing an image processing system in accordance with a first embodiment of the present invention,

FIG. 2 is a flow chart for illustrating operation of the image processing system of the first embodiment,

FIG. 3 is a block diagram showing an image processing apparatus in accordance with a second embodiment of the present invention,

FIG. 4 is a flow chart for illustrating operation of the image processing apparatus of the second embodiment,

FIG. 5 is a block diagram showing a modification of the image processing apparatus in accordance with the second embodiment of the present invention,

FIG. 6 is a block diagram showing another modification of the image processing apparatus in accordance with the second embodiment of the present invention,

FIG. 7 is a block diagram showing an image processing apparatus in accordance with a third embodiment of the present invention,

FIG. 8 represents the spatial frequency properties of the human vision as the visual sensitivity,

FIG. 9 is a flow chart for illustrating operation of the image processing apparatus of the third embodiment,

FIG. 10 is a block diagram showing an image generation apparatus in accordance with a fourth embodiment of the present invention,

FIG. 11 is a view showing frequency properties,

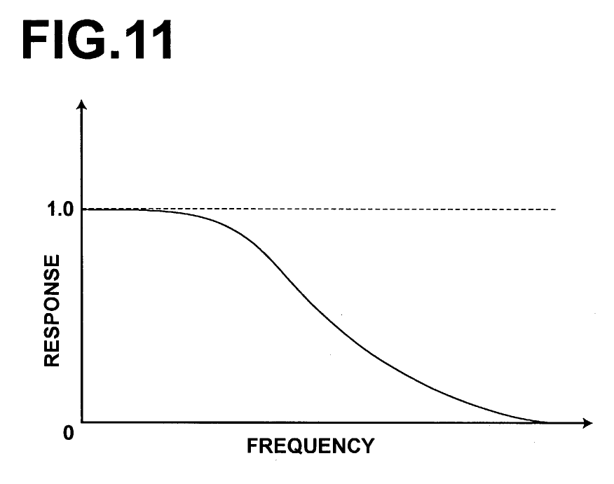

FIG. 12 is a flow chart for illustrating operation of the image generation apparatus of the fourth embodiment,

FIG. 13 is a block diagram showing an image processing apparatus in accordance with a fifth embodiment of the present invention, and

FIG. 14 is a flow chart for illustrating operation of the image processing apparatus of the fifth embodiment.

### DESCRIPTION OF THE PREFERRED EMBODIMENTS

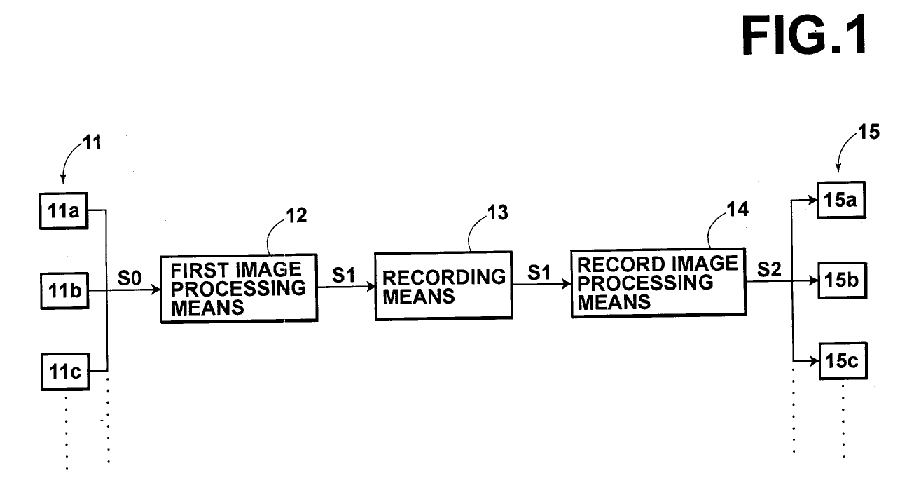

As shown in FIG. 1, an image processing system in accordance with a first embodiment of the present invention comprises a plurality of input devices 11 (11a, 11b, 11c . . . ) which obtain image data So, for instance, by reading out an image recorded on a photographic film, a first image processing means 12 which carries out first image processing on the image data So to obtain first processed image data S1, a recording means 13 which records the first processed image data S1 in a medium such as a hard disc, a CD-R, an MO or a memory card, a second image processing means 14 which reads out the first processed image data Si from the recording means 13 and carries out second image processing on the first processed image data S1 to obtain second processed image data S2, and a plurality of output devices 15 (15a, 15b, 15c . . . ) which output the second processed image data S2.

The input device 11 may be any known device so long as it can photoelectrically read an image on an original or various objects and output digital image data representing the image or the object. For example, the input device 11 may be an image scanner or a film scanner which photoelectrically reads out light reflected by the original or passing through the original by scanning the original with a spot beam or a two-dimensional beam, a digital camera, a digital video camera, or the like.

The output device 15 may be any image output medium so long as it forms a visible image or a latent image on the basis of the processed image data. For example, the output device 15 may be various printers employing photosensitive material, a thermal printer employing a heat-sensitive recording material or various monitors such as a CRT monitor or a liquid crystal monitor.

The image processing system of this embodiment may be provided with a plurality of a type of or different types of input devices 11 or output devices 15. For example, the image processing system of this embodiment may be provided with one or more image read-out apparatus and one or more digital camera, and with a plurality of types of (each one or more) or a type of printers.

The first image processing means 12 carries out first image processing on the image data So to transform image structure on the assumption that the image data is output through a predetermined supposed output device, thereby obtaining the first processed image data SI on the basis of which an image having structure conforming to the supposed output device can be reproduced.

When the supposed output device is too low in resolution and/or too small in output size, the amount of data in the first processed image data S1 is reduced as compared with the original image data So, which results in loss of information. The difference in image quality is not so large between when the image is printed at 300 dpi and at 600 dpi in the post card size or the L-size. Accordingly, when the supposed output device is too high in resolution and/or too large in output size, the amount of data in the first processed image data S1 becomes too large in spite that the resolution of the reproduced image is not greatly visually improved. Accordingly, in this particular embodiment, the supposed output device is an output device which outputs image data at resolution and size which are frequently used. For example, a supposed output device which prints out image in a post-card size at a resolution of 300 to 400 dpi will be sufficient for the general purpose.

When the input device 11 used is a film scanner, images reproduced on the basis of the original image data So include fine noises and the noises are often color noises due to granularity of the film. Accordingly, the first image processing means 12 carries out noise removal processing by the use of a relatively fine mask on the original image data So and carries out sharpness processing on the same so that the first processed image data S1 has frequency properties conforming to the resolution of the supposed output device.

Whereas, when the input device 11 used is a digital camera, the image data So is compressed in JPEG compression and accordingly, images reproduced on the basis of the original image data So include relatively large block noises more than fine noises. Further, since the image data So is subjected to YCC transformation upon the JPEG compression, noise is more included in the Y signal representing the brightness. Accordingly, the first image processing means 12 carries out YCC transformation on the original image data So to obtain a Y signal representing the brightness and then carries out noise removal processing by the use of a relatively rough mask on the Y signal, and carries out sharpness processing on the image data So so that the first processed image data S1 has frequency properties conforming to the resolution of the supposed output device.

The noise removal processing may be, for instance, processing in which probability of the pixel being a pixel on an edge is determined for all the pixels of an image represented by the original image data So by the use of an edge detecting filter corresponding to the mask size, and the degree of smoothing carried out on pixels which are determined to be a pixel on an edge is decreased whereas the degree of smoothing carried out on pixels which are determined not to be a pixel on an edge is increased.

When the sharpness processing is carried out according to the following formula (1), the sharpness processing and the noise removal processing may carried out at one time by increasing the enhancement coefficient β for the pixels which are determined to be a pixel on an edge and decreasing the same for the pixels which are determined not to be a pixel on an edge.

Sproc=Sorg+β×(Sorg−Sus) (1)

wherein Sproc represents the processed image data, Sorg represents the original image data, Sus represents the blurred image data and β represents the enhancement coefficient.

The blurred image data Sus is obtained by carrying out filtering processing using an unsharp mask on original image data Sorg. The size of the unsharp mask is selected to conform to the resolution of the supposed output device.

When the sharpness processing is carried out according to the above formula (1), the contrast (Sorg−Sus) of each pixel is calculated and the noise removal processing may be carried out by changing the degree of smoothing on the pixels according to the contrast of the pixels. As the contrast is larger, the probability that the pixel represents an edge is stronger, and as the contrast is smaller, the probability that the pixel represents a flat portion, where density change is small and noise is included more, is stronger. Accordingly, the degree of smoothing carried out on pixels which are small in contrast is decreased whereas the degree of smoothing carried out on pixels which are larger in contrast is increased.

The first image processing means 12 carries out on the original image data So the first image processing to transform structure of image and obtains first processed image data S1 on the basis of which an image of the same quality in structure irrespective of the kind of input device used.

The second image processing means 14 carries out second image processing on the first processed image data S1 to compensate for difference in output properties related to structure of image between the supposed output device and the output device 15 which actually outputs the image, thereby obtaining second processed image data S2.

Since the first processed image data S1 is capable of reproducing an image having structure conforming to the supposed output device but is incapable of reproducing an image having structure conforming to said the output device 15 which actually outputs the image, the second image processing means 14 carries out second image processing on the first processed image data S1 to nullify difference in image structure between the image reproduced on the basis of the first processed image data S1 by the supposed output device and the image reproduced on the basis of the second processed image data S2 by the output device 15 which actually outputs the image.

For example, when the supposed output device differs in resolution from the output device which actually outputs the image, enlargement/reduction processing must be carried out on the first processed image data S1. However enlargement/reduction processing deteriorates the sharpness of the image. Accordingly, the second image processing means 15 carries out on the first processed image data S1 sharpness processing so that the deteriorated sharpness becomes equivalent that of the first processed image data S1 or sharpness processing to compensate for difference in sharpness due to difference in resolution between the supposed output device and the output device 15 which actually outputs the image.

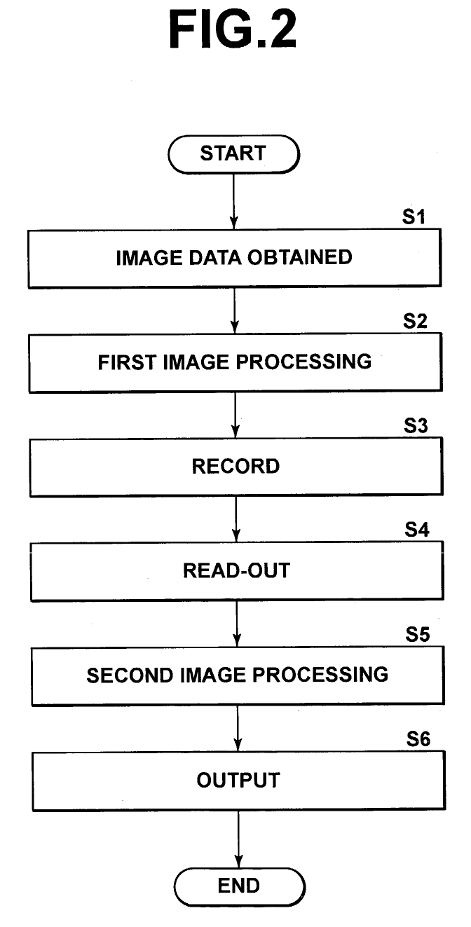

Operation of the imaging processing system of this embodiment will be described, hereinbelow, with reference to the flow chart shown in FIG. 2.

Original image data So is obtained through one of the input devices 11. (step S1) The first image processing means 12 carries out first image processing on the original image data So to transform image structure on the assumption that the image data is output through a predetermined supposed output device, thereby obtaining the first processed image data S1. (step S2) The recording means 13 records the first processed image data S1 in a medium. (step S3) Then the recording means 13 reads out the first processed image data S1 from the medium and the second image processing means 14 carries out second image processing on the first processed image data S1 to compensate for difference in output properties related to structure of image between the supposed output device and the output device 15 which actually outputs the image, thereby obtaining second processed image data S2. (steps S4 and S5) The second processed image data S2 is output through the output device 15. (step S6) As can be understood from the description above, in accordance with the image processing system of this embodiment, since the first image processing is carried out on the original image data So to transform structure of image on the assumption that the image data is output through a predetermined supposed output device, the first processed image data S1 on the basis of which an image having structure conforming to the supposed output device can be reproduced is obtained. Accordingly, the first processed image data S1 is capable of reproducing an image of the same quality in structure irrespective of the kind of the input device 11 used.

Further, since the second image processing is carried out on the first processed image data S1 to compensate for difference in output properties related to structure of image between the supposed output device and the output device 15 which actually outputs the image when outputting an image through the output device 15, the second processed image data S2 capable of reproducing an image of the same quality in structure irrespective of the kind of input device used can be obtained.

Further, since when outputting an image the output device 15 which actually outputs the image, only image processing to compensate for difference in output properties related to structure of image between the supposed output device and the output device 15 which actually outputs the image has to be carried out, the second processed image data S2 can be easily obtained.

Though, in the embodiment described above, the present invention is applied to an integrated system, the system may be divided into a first unit comprising the input devices 11, the first image processing means 12 and the recording means 13 and a second unit comprises the second image processing means 14 and the output devices 15. The first unit may be further divided into a unit comprising the input devices 11 and a unit Comprising the first image processing means 12 and the recording means 13.

Though, in the embodiment described above, the supposed output device outputs a print at a resolution of 300 dpi to 400 dpi, the supposed output device may be a monitor having a predetermined resolution since the first processed image data is often displayed on a monitor or the like.

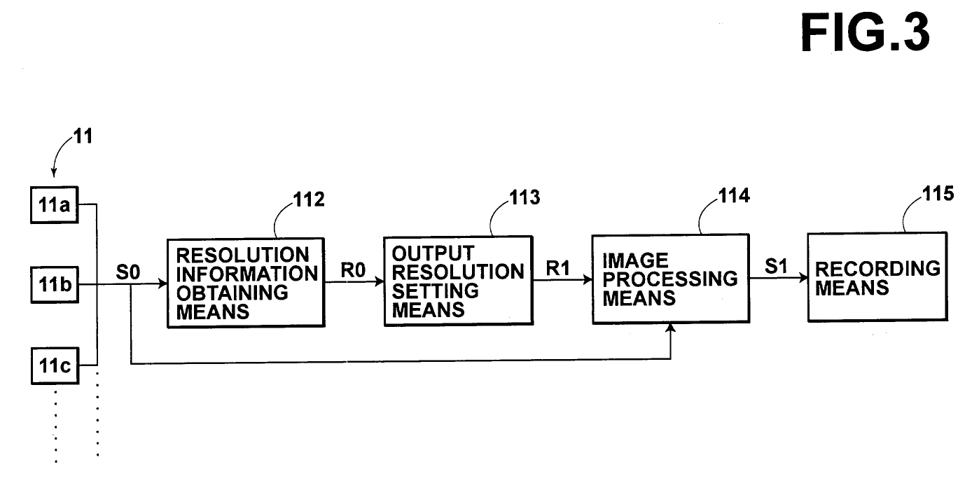

FIG. 3 is a block diagram showing an image processing apparatus in accordance with a second embodiment of the present invention. The image processing apparatus of this embodiment is based on the assumption that image data is output through a supposed output device having predetermined output resolution and comprises, as shown in FIG. 3, a plurality of input devices 11 (11a, 11b, 11c . . . ) which obtain image data So, for instance, by reading out an image recorded on a photographic film, a resolution information obtaining means 112 which obtains resolution information Ro representing the resolution of the image data So on the basis of a tag attached to the image data So, an output resolution setting means 113 which sets output resolution R1 of a supposed output device on the basis of the resolution information Ro of the image data So, an image processing means 114 which carries out image processing on the image data So to transform structure of image according to the set output resolution R1, thereby obtaining processed image data S1 on the basis of which an image having structure conforming to the supposed output device can be reproduced and a recording means 115 which records the processed image data S1 in a medium such as a hard disc, a CD-R, an MO or a memory card.

The input device 11 may be any known device so long as it can photoelectrically read an image on an original or various objects and output digital image data representing the image or the object. For example, the input device 11 may be an image scanner or a film scanner which photoelectrically reads out light reflected by the original or passing through the original by scanning the original with a spot beam or a two-dimensional beam, a digital camera, a digital video camera, or the like.

The image processing apparatus of this embodiment may be provided with a plurality of a type of or different types of input devices. For example, the image processing apparatus of this embodiment may be provided with one or more image read-out apparatus and one or more digital camera.

The resolution information obtaining means 112 obtains resolution information Ro on the resolution of the image data So on the basis of the number of pixels in the image data So, the kind of the input device 11 recorded on the tag of the image data So (in the case where the input device is a scanner, on the basis of the scan mode used and the size of the original from which the image data So is read, in addition to the factors listed above).

Though, the resolution information Ro of the image data So may represent simply the number of pixels in the image represented by the image data So, resolution can differ according to the kind of the input device even if the number of pixels is the same. For example, in the case of image data comprising three color data components of RGB, image data obtained by reading an original by an image scanner has originally three pieces of image information (of three colors) for each pixel. Whereas, image data obtained through a digital camera has originally only one piece of image information (of one of the three colors) for each pixel since a monolayer CCD for obtaining three color data components on each pixel is generally employed and pieces of image information of the other two colors are obtained by interpolation. Accordingly, even if the same in the number of pixels, image data obtained through an image scanner is higher in resolution than image data obtained through a digital camera. Further even for image data obtained through an image scanner, resolution varies according to the original scan mode, high image quality mode or high speed mode. Further even for image data obtained through an image scanner and in the same mode, resolution varies according to the size of the original, 135 film, APS film or Brownie film.

Accordingly, it is preferred that the resolution information Ro includes, as well as the number of pixels, various types of information affecting the resolution of image data such as on the kind of the input device, the scan mode, the original size and the like.

For example, when the input device 11 is a digital camera, the resolution obtaining means 112 takes as the resolution information Ro a value in the range of ⅓ to ½ of the number of pixels in the image represented by the image data So. When the input device 11 is a scanner and the high-speed mode is employed, the resolution obtaining means 112 takes as the resolution information Ro a value in the range of ⅓ to ½ of the number of pixels in the image represented by the image data So.

The output resolution setting means 113 sets the output resolution R1 of the supposed output device which is supposed to output the image data So on the basis of the resolution information Ro obtained by the resolution information obtaining means 112. In the case of image data obtained by reading out an image recorded on 135 film, the image data has 1,500,000 to 2,000,000 pixels and is generally output as a print in L-size to post card size. In this case, print resolution of about 300 dpi suffices. Accordingly, when the resolution information Ro represents a number of pixels of 1,500,000 to 2,000,000, the output resolution R1 is set as 300 dpi, L-size.

On the other hand, when the image data is obtained by reading an image recorded on Brownie film in a high-quality mode or obtained by a digital camera for professional use (where three color image data is obtained upon photographing for each pixel), the image data has more than 10,000,000 pixels. When the output resolution R1 of the supposed output device is set as 300 dpi, L-size for such high-resolution image data, a large part of the image information is lost by the image processing.

Accordingly, when the resolution information Ro represents a number of pixels more than 10,000,000, the output resolution R1 is set as, for instance, 600 dpi, A4 size so that image information included in the image data So is not lost.

The image processing means 114 carries out image processing on the image data So to transform structure of image according to the set output resolution R1 on the assumption that the image data So is output through the supposed output device, thereby obtaining processed image data S1 on the basis of which an image having structure conforming to the supposed output device can be reproduced.

Assuming that an image is printed on a 2L-size photosensitive material at 300 dpi (case 1) and that an image is printed on an L-size photosensitive material at 600 dpi (case 2), the print obtained in case 1 and the print obtained in case 2 are the same in the number of pixels but are different in viewing conditions. That is, the sensitivity of the human eye is higher in the frequency band about 2 to 5 cycle/degree, and it is important to correct the sharpness and to remove noise in this frequency band. The 2L-size print is larger than the L-size print in viewing distance. Accordingly, through the print obtained in case 1 and the print obtained in case 2 are the same in the number of pixels but difference from each other in the frequency band in which the sharpness processing or the noise removal processing is to be, carried out. The image processing means 114 changes the frequency band in which the image processing is carried out on the image data So according to the set output resolution R1 and obtains processed image data S1.

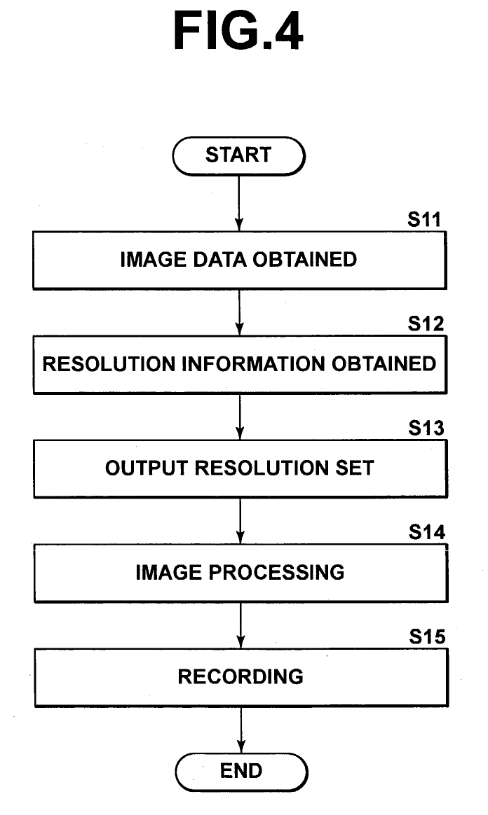

Operation of the image processing apparatus of this embodiment will be described with reference to the flow chart shown in FIG. 4.

Original image data So is obtained through one of the input devices 11. (step S11) The a resolution information obtaining means 112 obtains resolution information Ro representing the resolution of the image represented by the image data So. (step S12) Then the output resolution setting means 113 sets output resolution R1 of a supposed output device on the basis of the resolution information Ro (step S13), the image processing means 114 carries out image processing on the image data So to transform structure of image according to the set output resolution R1, thereby obtaining processed image data S1 (step S14) and the recording means 115 records the processed image data S1 in a medium (step S15).

As can be understood from the description above, in accordance with the image processing apparatus of this embodiment, resolution information Ro on the resolution of the image data So is obtained, output resolution R1 is set on the basis of the resolution information Ro on the assumption that the image data is output through a predetermined supposed output device having a predetermined output resolution, and an image processing is carried out on the image data So to transform structure of image according to the set output resolution R1. Accordingly, the output resolution R1 of the supposed output device can be set high when the resolution of the image data So is high, whereby image processing to transform structure of image can be carried out without loss of image information.

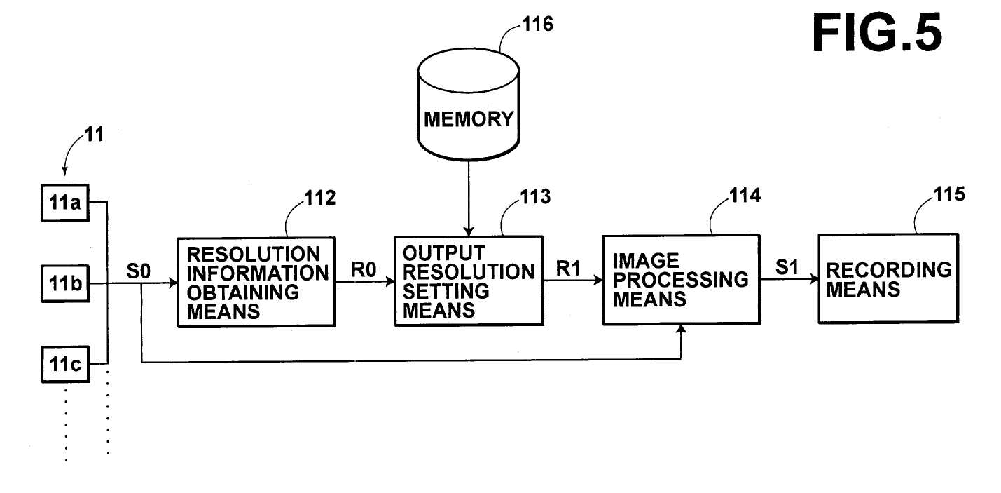

Though, in the embodiment described above, the output resolution R1 of the supposed output device is set on the basis of the resolution information Ro, the output resolution R1 may be selected from a plurality of output resolutions R2 stored in a memory 116 in correlation with the various values of resolution information Ro in the modification shown in FIG. 5.

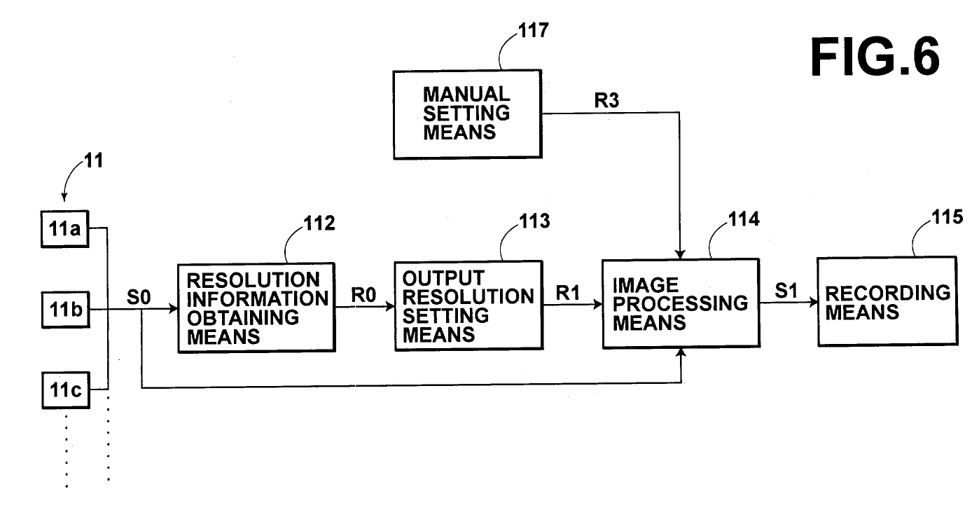

In the modification shown in FIG. 6, the output resolution can be manually set to any output resolution R3 irrespective of the resolution of the image data So by a manual setting means 117. With this arrangement, the image data So can be constantly output at a general-purpose out resolution (e.g., L-size, 300 dpi) irrespective of the resolution of the image data So.

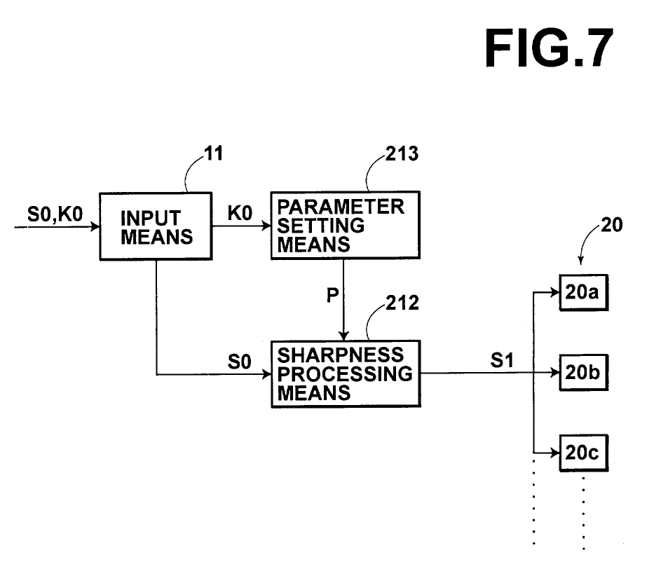

FIG. 7 is a block diagram showing an image processing apparatus in accordance with a third embodiment of the present invention. The image processing apparatus of this embodiment is for carrying out sharpness processing on image data So to obtain processed image data S1 and outputting the processed image data S1 through one of a plurality of output devices 20 (20a, 20b, 20c . . . ) and comprises, as shown in FIG. 7,

an input means 11 through which image data So and image data output conditions Ko are input,

a parameter setting means 213 which sets a parameter P of the sharpness processing on the basis of the image data output conditions Ko, and

a sharpness processing means which carries out the sharpness processing on the basis of the set parameter P, thereby obtaining processed image data S1.

The output conditions Ko includes, for instance, the kind of output device 20 which actually outputs the processed image data S1, the output size of the processed image data S1 and the output resolution of the processed image data S1. The output size means physical size, for instance, of a photosensitive material or a monitor on which the processed image data S1 is reproduced, e.g., an L-size print, an A4-size print or a 15″ print. The output resolution is resolution at which the processed image data Si is reproduced on an output medium, and is represented by the number of dots per inch like 300 dpi or 400 dpi.

The sharpness processing means 212 carries out sharpness processing represented by the following formula (2) on the image data So and obtains processed image data.

S1=So+β×(So−Sous) (2)

wherein Sous represents the blurred image data and β represents the enhancement coefficient.

The blurred image data Sous is obtained by carrying out filtering processing using an unsharp mask on the image data So. As the unsharp mask, a filter for two-dimensionally carrying out filtering processing on the image data So (e.g., 3×3 or 5×5) is used.

The parameter setting means 213 sets the parameter P of the sharpness processing on the basis of the output size and the out resolution represented by the output conditions Ko so that sharpness in an optimal frequency band is improved taking into account the human visual properties. For example, the parameter setting means 213 sets a filter size of the unsharp mask for obtaining the blurred image data Sous.

The human eye is sensitive to sharpness and/or contrast in a certain frequency band. The signal level in the frequency band greatly affects structural look of the image. The spatial frequency properties of the human vision can be expressed by fineness of signals versus the angle of view and can be represented in terms of cycle/degree (will be referred to as “cpd”, hereinbelow. For example, 1 cpd means there is one periodic signal per 1° of the angle of view.

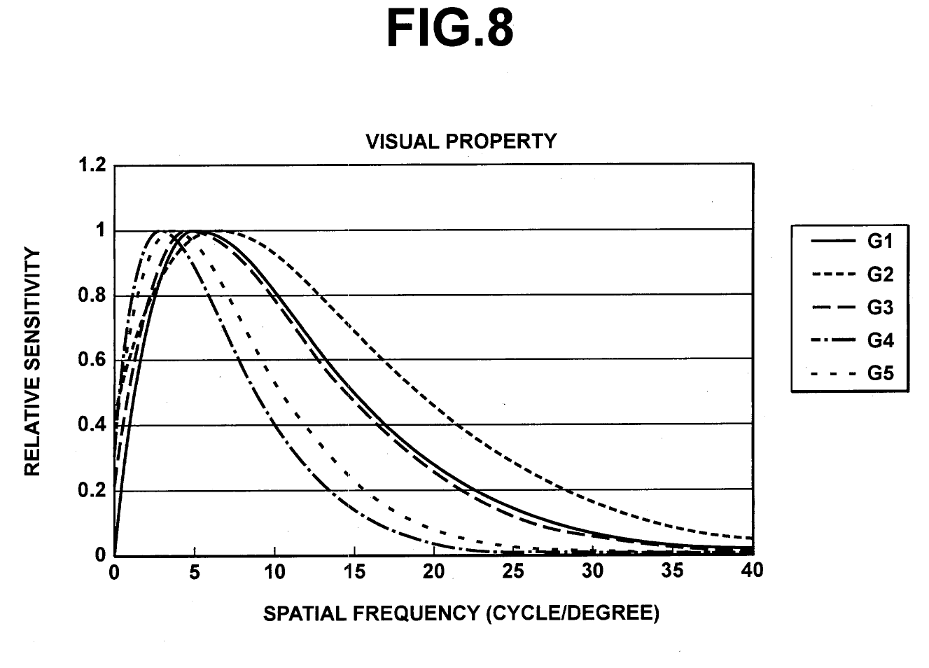

FIG. 8 represents the spatial frequency properties of the human vision as the visual sensitivity. In FIG. 8, curve G1 shows relative sensitivity obtained through calculation 5.05exp(−0.138u)(1−exp(−0.1u)), curve G2 shows relative sensitivity obtained through calculation 2.6(0.192+0.114u)exp(−(0.114u)1.1), curve G3 shows relative sensitivity obtained through calculation (0.2+0.45u)exp(−0.18u), curve G4 shows relative sensitivity obtained through calculation (0.31+0.69u)exp(−0.29u), and curve G5 shows relative sensitivity obtained through calculation 2.46(0.1+0.25u)exp(−0.25u). u represents the spatial frequency (cycle/degree).

As can be understood from FIG. 8, the spatial frequency properties of the human vision have a peak near 2 to 7 cpd. Accordingly it is important to match in structural look all the images output through the output devices 20. The spatial frequency properties of the human vision depends upon the viewing distance, the distance at which the image is viewed. When the viewing distance is represented by d (mm), the relation between the spatial frequency properties a (cpd) of the human vision and the spatial frequency b (cycle/mm) is as represented by the following formula (3).

a=π·d/180·b (3)

According to formula (3), 1 cpd=0.191 cycle/mm when the viewing distance is 30 cm.

In order to match reproduced images in structural look, the sharpness processing is carried out supposing a certain viewing distance. However, the viewing distance varies with the change of the size of the output medium. For example, assuming that the output medium is a print, the viewing distance is small in the case of an L-size print which is relatively small and large in the case of an A4-size print which is relatively large.

The parameter setting means 213 sets the parameter P of the sharpness processing, that is, size of the unsharp mask, taking into account the output size included in the output conditions Ko. Assuming that the output media are L-size prints and A4-size prints, it is necessary to adjust the signals in the 0.573 cycle/mm frequency band in the case of the L-size prints and in the 0.382 cycle/mm frequency band in the case of the A4-size prints in order to adjust the sharpness near 2 cpd. That is, the parameter setting means 213 sets the parameter P of the sharpness processing, that is, size of the unsharp mask, so that the signals in the 0.573 cycle/mm frequency band is adjusted in the case of the L-size prints and in the 0.382 cycle/mm frequency band in the case of the A4-size prints. For example, when the output medium is an A4-size print, the size of the unsharp mask is increased as compared with when the output medium is an L-size print.

When a 400 dpi printer and a 300 dpi printer output the processed image data S1 in L-size, the 400 dpi printer requires a larger unsharp mask than the 300 dpi printer. The parameter setting means 213 sets the parameter P taking into account also the output resolution included in the output conditions Ko.

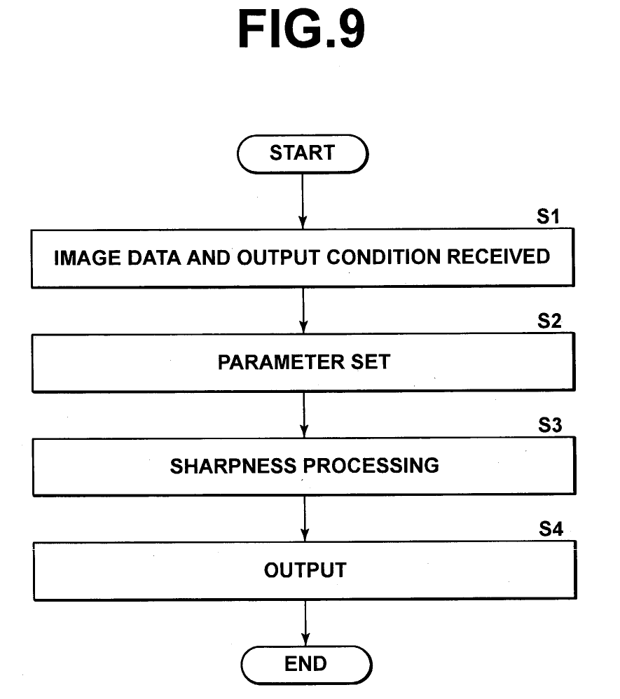

Operation of the image processing apparatus of this embodiment will be described, hereinbelow, with reference to the flow chart shown in FIG. 9. First the input means 11 receives input of image data So and output conditions Ko. (step S21) Then the parameter setting means 213 sets a parameter P of sharpness processing on the basis of the output conditions Ko. (step S22) The sharpness processing means 212 carries out sharpness processing on the image data So on the basis of the set parameter P, thereby obtaining processed image data S1. (step S23) The processed image data SI is output through one of the output device 20 designated by the output conditions Ko after further subjected to image processing such as gradation transformation and/or color correction by an image processing means not shown. (step S24)

As can be understood from the description above, in the image processing apparatus of this embodiment, since the parameter P of the sharpness processing is set on the basis of the output size and output resolution of the processed image data S1, sharpness processing which improves the sharpness in a frequency band where the human eye is higher in sensitivity at the viewing distance for the output size can be carried out on the original image data So. Further, sharpness processing which is suitable for the output resolution of the processed image data S1 (which also can affect the parameter P of sharpness processing) can be carried out on the original image data So since the parameter P of sharpness processing is set on the basis of the output resolution. Accordingly, image data from which an image which is substantially constant in structural look irrespective of the viewing distance, which varies according to the output size, can be reproduced can be obtained.

Though, in the image processing apparatus of this embodiment, the sharpness processing is carried out on the original image data So according to the above formula (2), the sharpness processing may be carried out by any other method. For example, though, in the above embodiment, the filter size of the unsharp mask is set, the degree of enhancement in a frequency band where the visual sensitivity is higher may be adjusted by the use of sharpness processing disclosed in Japanese Unexamined Patent Publication No. 10(1998)-75395 where an unsharp mask having a plurality of filter sizes and sharpness is adjusted in a plurality of frequency bands.

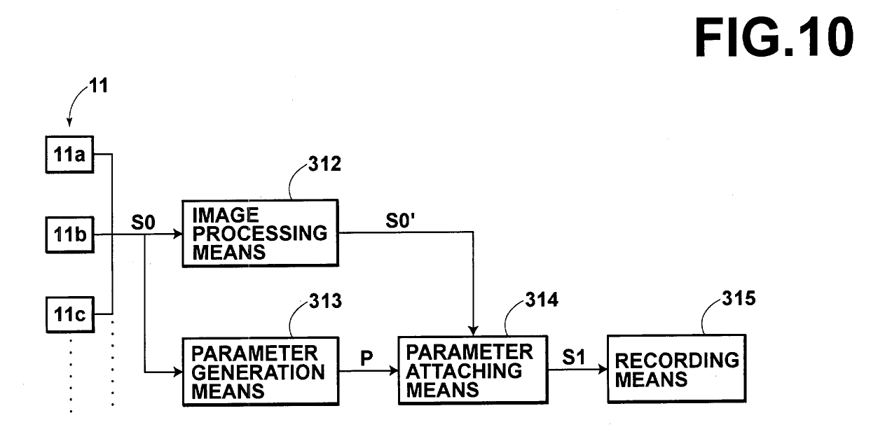

FIG. 10 is a block diagram showing an image generation apparatus in accordance with a fourth embodiment of the present invention. The image generation apparatus of this embodiment comprises, as shown in FIG. 10, a plurality of input devices 11 (11a, 11b, 11c . . . ) which obtain image data So, for instance, by reading out an image recorded on a photographic film, an image processing means 312 which carries out enlargement/reduction processing and sharpness processing on the image data So on the assumption that the image data So is printed in a reference print size, thereby obtaining processed image data So′, a parameter generation means 313 which generates a parameter P for sharpness processing for carrying out sharpness processing on the processed imaged data So′ on the assumption that the image data So is printed in a size different from the reference print size, a parameter attaching means 314 which attaches to the processed image data So′ the parameter P, thereby obtaining image data S1 with a parameter P and a recording means 315 which records the image data S1 in a medium such as a hard disc, a CD-R, an MO or a memory card.

The input device 11 may be any known device so long as it can photoelectrically read an image on an original or various objects and output digital image data representing the image or the object. For example, the input device 11 may be an image scanner or a film scanner which photoelectrically reads out light reflected by the original or passing through the original by scanning the original with a spot beam or a two-dimensional beam, a digital camera, a digital video camera, or the like.

The image generation apparatus of this embodiment may be provided with a plurality of a type of or different types of input devices. For example, the image generation apparatus of this embodiment may be provided with one or more image read-out apparatus and one or more digital camera.

The image processing means 312 carries out enlargement/reduction processing and sharpness processing on the image data So on the assumption that the image data So is printed in a reference print size. For example, the image processing means 312 carries out sharpness processing represented by the following formula (4) on the image data So and obtains image data Sos. At the same time, the image processing means 312 carries out enlargement/reduction processing on the image data Sos by linear interpolation, spline interpolation or the like. The sharpness processing and the enlargement/reduction processing may be carried out in any order.

Sos=So+β×(So−Sous) (4)

wherein Sous represents the blurred image data and β represents the enhancement coefficient.

In this particular embodiment, the reference print size is L-size. The blurred image data Sous is obtained by carrying out filtering processing using an unsharp mask of a predetermined size with a predetermined mask coefficient on original image data So.

The parameter generation means 313 generates a parameter for sharpness processing for processing the image data So′ so that the structural look of a print obtained when the image data So′ is output in a size different from the reference print size (L-size) is equivalent to that of a print obtained when the image data So′ is output in the reference print size (L-size).

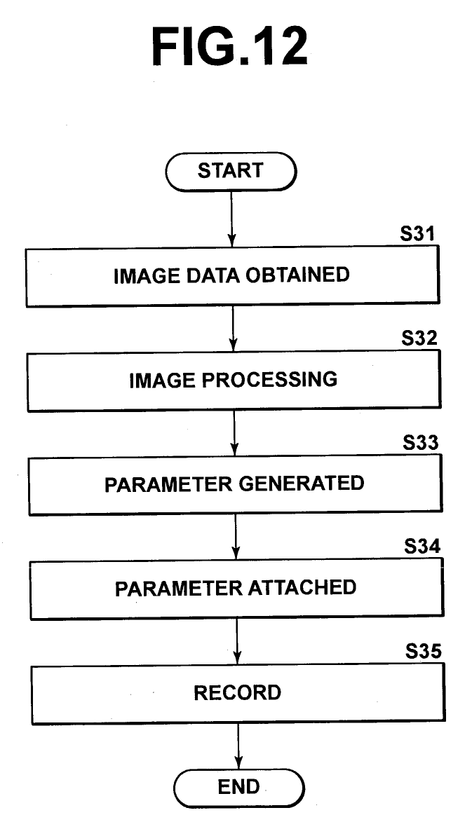

For example, when the image data So′ is to be printed in 2L-size, it is necessary to enlarge the image data So′ by about 140%. Though enlargement/reduction processing can be carried out by various calculations such as comprising linear interpolation, spline interpolation and the like, the degree of deterioration in sharpness can be calculated on the basis of the relation with the factor of enlargement when the calculation is known. For example, assuming that the response in frequency properties is 1.0 over the entire frequency band when the image data So′ is printed in L-size as shown in FIG. 12, deterioration in the response in frequency properties (shown by the solid line In FIG. 12) when the image data So′ is printed in 2L-size can be calculated.

The parameter generation means 313 generates a parameter for compensating for deteriorated response in the frequency properties according to the print size. For example, the parameter generation means 313 generates a size of the unsharp mask, a mask coefficient and an enhancement coefficient as the parameter P. The parameter P is obtained for each method of calculation of enlargement/reduction processing. The parameter P may be generated on the assumption that the image data So′ is to be printed in size other than 2L-size, e.g., postcard size or A4-size. In this case, the parameter P is obtained for each method of calculation of enlargement/reduction processing and for each print size. In this case, the parameters P for sizes other than 2L-size may be the difference in response in the frequency properties between when the image data So′ is printed in the print size and when the image data So′ is printed in 2L-size (e.g., the ratio of the former response to the latter response) in place of a size of the unsharp mask, a mask coefficient and an enhancement coefficient.

The parameter attaching means 314 records the parameter P generated by the parameter generation means 313 in the header of the image data So′, thereby obtaining image data S1 with a parameter P.

The parameter P may be attached to the image data So′ by, for instance, relating the file name of the image data So to the file name of the parameter P, for instance, by naming the former 001 .jpg and the latter 00.1 P.jpg, instead of recording the parameter P in the header of the image data So′.

Operation of the image generation apparatus of this embodiment will be described, hereinbelow, with reference to the flow chart shown in FIG. 12. First the input means 11 obtains image data So. (step S31) Then the image processing means 312 carries out image processing consisting of enlargement/reduction processing and sharpness processing on the image data So on the assumption that the image data So is printed in L-size, a reference print size, thereby obtaining processed image data So′,. (step S32) The parameter generation means 313 generates a parameter P for sharpness processing for carrying out sharpness processing on the processed imaged data So′ on the assumption that the image data So is printed in a size different from the reference print size (step S33), the parameter attaching means 314 attaches to the processed image data So′ the parameter P, thereby obtaining image data S1 with a parameter P (step S34) and the recording means 315 records the image data S1 in a medium (step S35).

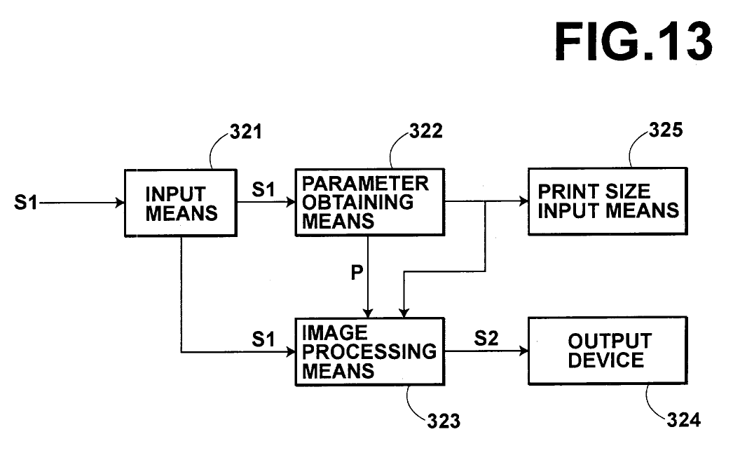

FIG. 13 is a block diagram showing an image processing apparatus in accordance with a fifth embodiment of the present invention. The image processing apparatus of this embodiment is for carrying out sharpness processing on the image data S1 output from the image generation apparatus of the above embodiment so that a print obtained by outputting the image data S1 in a print size different from the reference print size is equivalent in structural look to a print obtained by outputting the image data S1 in the reference print size, and comprises, as shown in FIG. 13, an input means 321 which receives input of the image data S1, a parameter obtaining means 322 which obtains the parameter P attached to the image data S1, an image processing means 323 which carries out sharpness processing on the image data S1 on the basis of the parameter P obtained, carries out enlargement/reduction processing on the image data S1 to transform the image data S1 to image data of size suitable for print, and carries out color correction processing and gradation transformation processing on the same, thereby obtaining processed image data S2, an output device 324 which outputs the processed image data S2 and a print size input means 325 which inputs the print size into the parameter obtaining means 322 and the image processing means 323.

The parameter obtaining means 322 obtains the parameter P attached to the image data S1 on the basis of the print size input from the print size input means 325 and the method of calculation of enlargement/reduction processing carried out by the image processing means 323. For example, when the print size is 2L and the method of calculation of enlargement/reduction processing is spline interpolation, the parameter obtaining means 322 obtains from the image data S1 a parameter P conforming to 2L size and spline interpolation.

The image processing means 323 carries out sharpness processing on the image data S1 on the basis of the parameter P obtained by the parameter obtaining means 322, carries out enlargement/reduction processing on the image data S1 to transform the image data S1 to image data of size suitable for print, and carries out color correction processing and gradation transformation processing on the same, thereby obtaining processed image data S2.

The output device 324 may be any image output medium so long as it forms a visible image or a latent image on the basis of the processed image data S2. For example, the output device 324 may be various printers employing photosensitive material, a thermal printer employing a heat-sensitive recording material or the like.

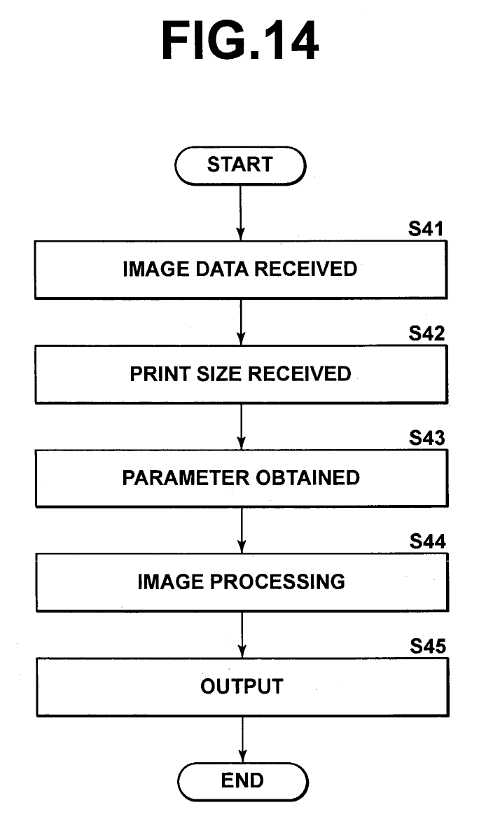

Operation of the image processing apparatus of this embodiment will be described, hereinbelow, with reference to the flow chart shown in FIG. 14. First the input means 321 receives input of the image data S1. (step S41) Then the print size input means 325 receives input of the print size (step S42) and the parameter obtaining means 322 obtains the parameter P attached to the image data S1 on the basis of the input print size (set S43). The image processing means 323 which carries out image processing including sharpness processing on the image data S1 on the basis of the parameter P obtained, thereby obtaining processed image data S2, and the output device 324 outputs the processed image data S2. (steps S44 and S45)

In accordance with the image processing apparatus of the above embodiment, since a parameter P suitable for carrying out sharpness processing on the image data S1, on the assumption that the image data Si is output in a print size different from the reference print size, so that the image data S1 has sharpness conforming to the print size is attached to the image data S1, the parameter P for carrying out image processing conforming to the print size in which the image data S1 is to be output can be easily obtained. By carrying out image processing including sharpness processing on the image data S1 on the basis of the parameter P obtained, sharpness processing can be efficiently carried out and processed image data S2 which can output a print which is the same in structural look irrespective of the print sizes can be efficiently obtained.

Though, in the embodiment described above, the image data S1 is printed in a size different, from the reference print size, the image data S1, as it is, is input into the image processing means 323 and only color correction processing and gradation transformation processing are carried out on the image data S1 when the image data S1 is to be output in the reference print size.

The method of enlargement/reduction assumed by the parameter generation means 313 and that assumed by the image processing means 323 sometimes differ from each other. Accordingly, the parameter generation means 313 may generate a parameter P suitable for the case where the image data So′ is enlarged or reduced by a certain method (e.g., spline interpolation) with a correction coefficient for enhancement attached to the image data S1 as the parameter P on the assumption that the method of enlargement/reduction assumed by the parameter generation means 313 and that assumed by the image processing means 323 differ from each other In this case, the parameter P comprises the size of the unsharp mask, the mask coefficient, the degree of enhancement and the correction coefficient of enhancement. The image processing means 323 carries out sharpness processing on the image data S1 on the basis of the correction coefficient of enhancement included in the parameter P.

Though, in the embodiment described above, size of the unsharp mask, a mask coefficient and enhancement corresponding to the method of calculation for the enlargement/reduction processing are employed as the parameter P, the volume of the parameter P becomes too large when these parameters are attached to the image data S1 for all the print sizes supposed. Accordingly, only parameters for typical factors of enlargement/reduction (e.g., 140%, 200% and 240%) may be attached to the image data S1. In this case, when the image data S1 is to be enlarged or reduced by a factor between the typical factors, the parameter for the factor of enlargement/reduction is calculated by interpolation.

When the input device 11 is a scanner, the resolution upon reading may be sometimes changed on the basis of the supposed print size. For example, when the image is to be printed in L-size, the image is read at 400 dpi whereas when the image is to be printed in 2L-size, the image is read at 600 dpi. Depending on the kind of the scanner, the sharpness of the image obtained varies according to the resolution upon reading. When the sharpness varies according to resolution of the image data So, and two pieces of image data different in reading resolution are printed in the same size, the prints obtained are different in structural look.

Accordingly, in this case, it is preferred that the reading resolution of the image data So and difference in response in frequency properties corresponding to the reading resolution be attached to the image data So′ as the parameter P. For example, when the reading resolution is either 400 dpi or 600 dpi, difference between the response in the frequency properties of image data at 400 dpi and that of image data at 600 dpi (e.g., the ratio therebetween) and reading resolution of the image data are attached to the image data So′ as the parameter P. Otherwise, the parameter P may be calculated taking into account the difference in response in the frequency properties due to difference in the reading resolution and may be attached to the image data So′.

With this arrangement, when the image data S1 is to be printed in a size different to the reference print size (L-size), sharpness processing can be carried out on the image data SI by the image processing means 323 taking into account the resolution at which the image data S1 is read.

Further, though in the embodiment described above, sharpness processing is carried out as the image structure transformation processing, noise removal processing for removing noise may be carried out as the image structure transformation processing and both the sharpness processing and the noise removal processing may be carried out as the image structure transformation processing.

As the parameter for the noise removal processing, a value representing the degree of smoothing can be employed.

What is claimed is:

1. An image processing method of carrying out predetermined image processing on image data taken in through one of a plurality of kinds of input devices and outputs the processed image data through one of a plurality of kinds of output devices, wherein the improvement comprises the steps of
carrying out first image processing on the image data to transform structure of image on the assumption that the image data is output through a predetermined supposed output device, thereby obtaining first processed image data on the basis of which an image having structure conforming to the supposed output device can be reproduced,
carrying out second image processing on the first processed image data to compensate for difference in output properties related to structure of image between the supposed output device and said one of a plurality of kinds of output devices, thereby obtaining second processed image data, and
outputting the second processed image data through said one of a plurality of kinds of output devices.

2. An image processing method of carrying out predetermined image processing on image data taken in through one of a plurality of kinds of input devices and outputs the processed image data through one of a plurality of kinds of output devices, wherein the improvement comprises the step of
carrying out first image processing on the image data to transform structure of image on the assumption that the image data is output through a predetermined supposed output device, thereby obtaining first processed image data on the basis of which an image having structure conforming to the supposed output device can be reproduced.

3. An image processing method in which, when the first processed image data obtained by image processing method as defined in claim 2 is output through said one of a plurality of kinds of input devices, second image processing is carried out on the first processed image data to compensate for difference in output properties related to structure of image between the supposed output device and said one of a plurality of kinds of output devices, thereby obtaining second processed image data.

4. An image processing system for carrying out predetermined image processing on image data taken in through one of a plurality of kinds of input devices and outputs the processed image data through one of a plurality of kinds of output devices, wherein the improvement comprises
a first image processing means which carries out first image processing on the image data to transform structure of image on the assumption that the image data is output through a predetermined supposed output device, thereby obtaining first processed image data on the basis of which an image having structure conforming to the supposed output device can be reproduced, and
a second image processing means which carries out second image processing on the first processed image data to compensate for difference in output properties related to structure of image between the supposed output device and said one of a plurality of kinds of output devices, thereby obtaining second processed image data,
the second processed image data being output through said one of a plurality of kinds of output devices.

5. An image processing apparatus for carrying out predetermined image processing on image data taken in through one of a plurality of kinds of input devices and outputs the processed image data through one of a plurality of kinds of output devices, wherein the improvement comprises
an image processing means carrying out first image processing on the image data to transform structure of image on the assumption that the image data is output through a predetermined supposed output device, thereby obtaining first processed image data on the basis of which an image having structure conforming to the supposed output device can be reproduced.

6. An image processing apparatus comprising a second image processing means which, when the first processed image data obtained by image processing method as defined in claim 2 is output through said one of a plurality of kinds of input devices, carries out second image processing on the first processed image data to compensate for difference in output properties related to structure of image between the supposed output device and said one of a plurality of kinds of output devices, thereby obtaining second processed image data.

7. A computer program for causing a computer to perform an image processing method of carrying out predetermined image processing on image data taken in through one of a plurality of kinds of input devices and outputs the processed image data through one of a plurality of kinds of output devices, wherein the improvement comprises the steps of
carrying out first image processing on the image data to transform structure of image on the assumption that the image data is output through a predetermined supposed output device, thereby obtaining first processed image data on the basis of which an image having structure conforming to the supposed output device can be reproduced,
carrying out second image processing on the first processed image data to compensate for difference in output properties related to structure of image between the supposed output device and said one of a plurality of kinds of output devices, thereby obtaining second processed image data, and
outputting the second processed image data through said one of a plurality of kinds of output devices.

8. A computer-readable medium in which a computer program defined claim 7 is recorded.

9. A computer program for causing a computer to perform an image processing method of carrying out predetermined image processing on image data taken in through one of a plurality of kinds of input devices and outputs the processed image data through one of a plurality of kinds of output devices, wherein the improvement comprises the step of
carrying out first image processing on the image data to transform structure of image on the assumption that the image data is output through a predetermined supposed output device, thereby obtaining first processed image data on the basis of which an image having structure conforming to the supposed output device can be reproduced.

10. A computer-readable medium in which a computer program defined claim 9 is recorded.

11. A computer program for causing a computer to perform an image processing method in which, when the first processed image data obtained by image processing method as defined in claim 2 is output through said one of a plurality of kinds of input devices, second image processing is carried out on the first processed image data to compensate for difference in output properties related to structure of image between the supposed output device and said one of a plurality of kinds of output devices, thereby obtaining second processed image data.

12. A computer-readable medium in which a computer program defined claim 11 is recorded.

13. An image processing method of carrying out predetermined image processing on image data taken in through an input device comprising the steps of
obtaining resolution information on the resolution of the image data,
setting output resolution on the basis of the resolution information on the assumption that the image data is output through a predetermined supposed output device having a predetermined output resolution, and
carrying out image processing on the image data to transform structure of image according to the set output resolution, thereby obtaining processed image data on the basis of which an image having structure conforming to the supposed output device can be reproduced.

14. An image processing method as defined in claim 13 in which the output resolution is set by selecting an output resolution corresponding to the resolution information from a plurality of values of output resolution.

15. An image processing method as defined in claim 13 in which the output resolution is set by receipt of input of the output resolution.

16. An image processing apparatus for carrying out predetermined image processing on image data taken in through an input device comprising
a resolution information obtaining means which obtains resolution information on the resolution of the image data,
an output resolution setting means which sets output resolution on the basis of the resolution information on the assumption that the image data is output through a predetermined supposed output device having a predetermined output resolution, and
an image processing means which carries out image processing on the image data to transform structure of image according to the set output resolution, thereby obtaining processed image data on the basis of which an image having structure conforming to the supposed output device can be reproduced.

17. An image processing apparatus as defined in claim 16 in which the output resolution setting means sets the output resolution by selecting an output resolution corresponding to the resolution information from a plurality of values of output resolution.

18. An image processing apparatus as defined in claim 16 in which the output resolution setting means sets the output resolution by receipt of input of the output resolution.

19. A computer program for causing a computer to perform an image processing method of carrying out predetermined image processing on image data taken in through an input device comprising the steps of
obtaining resolution information on the resolution of the image data,
setting output resolution on the basis of the resolution information on the assumption that the image data is output through a predetermined supposed output device having a predetermined output resolution, and
carrying out image processing on the image data to transform structure of image according to the set output resolution, thereby obtaining processed image data on the basis of which an image having structure conforming to the supposed output device can be reproduced.

20. A computer program as defined in claim 19 in which the output resolution is set by selecting an output resolution corresponding to the resolution information from a plurality of values of output resolution.

21. A computer program as defined in claim 19 in which the output resolution is set by receipt of input of the output resolution.

22. A computer-readable medium in which a computer program defined claim 19 is recorded.

23. A computer-readable medium as defined in claim 22 in which the output resolution is set by selecting an output resolution corresponding to the resolution information from a plurality of values of output resolution.

24. A computer-readable medium as defined in claim 22 in which the output resolution is set by receipt of input of the output resolution.

25. An image processing method for carrying out sharpness processing on image data to obtain processed image data wherein the improvement comprises the steps of
setting a parameter of the sharpness processing on the basis of output size and output resolution of the processed image data, and
carrying out the sharpness processing on the basis of the set parameter.

26. An image processing apparatus for carrying out sharpness processing on image data to obtain processed image data wherein the improvement comprises
a parameter setting means which sets a parameter of the sharpness processing on the basis of output size and output resolution of the processed image data, and
a sharpness processing means which carries out the sharpness processing on the basis of the set parameter.

27. A computer program for causing a computer to perform the image processing method for carrying out sharpness processing on image data to obtain processed image data wherein the improvement comprises the steps of
setting a parameter of the sharpness processing on the basis of output size and output resolution of the processed image data, and
carrying out the sharpness processing on the basis of the set parameter.

28. A computer-readable medium in which a computer program defined claim 27 is recorded.

29. An image generation method of generating image data which is displayed on a display medium, wherein the improvement comprises the step of
attaching to the image data a processing parameter for carrying out image structure transformation processing on the image data so that an image reproduced from the image data is of structure conforming to the various sizes in which the image is displayed.

30. An image generation method as defined in claim 29 in which the display medium is a print.

31. An image generation method as defined in claim 30 in which the image data is generated on the assumption that the image data is printed in a reference print size and the various sizes are print sizes different from the reference print size.

32. An image generation method as defined in claim 29 in which the image data attached with the processing parameter is stored in a recording medium.

33. An image processing method comprising the steps of
obtaining a processing parameter corresponding to a predetermined display size from the image data generated by the image generation method defined in claim 29, and
carrying out image structure transformation processing on the image data on the basis of the processing parameter,
thereby obtaining processed image data.

34. An image generation apparatus for generating image data which is displayed on a display medium, wherein the improvement comprises
a processing parameter attaching means which attaches to the image data a processing parameter for carrying out image structure transformation processing on the image data so that an image reproduced from the image data is of structure conforming to the various sizes in which the image is displayed.

35. An image generation apparatus as defined in claim 34 in which the display medium is a print.

36. An image generation apparatus as defined in claim 35 in which the image data is generated on the assumption that the image data is printed in a reference print size and the various sizes are print sizes different from the reference print size.

37. An image generation apparatus as defined in claim 34 further comprising a recording means which records the image data attached with the processing parameter in a recording medium.

38. An image processing apparatus comprising
a processing parameter obtaining means which obtains a processing parameter corresponding to a predetermined display size from the image data generated by the image generation method defined in claim 29, and
an image processing means which carries out image structure transformation processing on the image data on the basis of the processing parameter, thereby obtaining processed image data.

39. A computer program for causing a computer to perform the image generation method of generating image data which is displayed on a display medium, wherein the improvement comprises the step of
attaching to the image data a processing parameter for carrying out image structure transformation processing on the image data so that an image reproduced from the image data is of structure conforming to the various sizes in which the image is displayed.

40. A computer program as defined in claim 39 in which the display medium is a print.

41. A computer program as defined in claim 40 in which the image data is generated on the assumption that the image data is printed in a reference print size and the various sizes are print sizes different from the reference print size.

42. A computer program as defined in claim 39 in which the image generation method further comprises the step of storing the image data attached with the processing parameter in a recording medium.

43. A computer program for causing a computer to perform an image processing method comprising the steps of
obtaining a processing parameter corresponding to a predetermined display size from the image data generated by the image generation method defined in claim 29, and
carrying out image structure transformation processing on the image data on the basis of the processing parameter,
thereby obtaining processed image data.
